(19) United States
(12) Patent Application Publication
(10) Pub. No.: US 2025/0174861 A1
(43) Pub. Date: May 29, 2025

(54) BATTERY PACK DRAIN ASSEMBLY

(71) Applicant: GM Global Technology Operations LLC, Detroit, MI (US)

(72) Inventors: Timothy Glenn Ross, Washington, MI (US); Alex Paulsen, Royal Oak, MI (US)

(21) Appl. No.: 18/521,135

(22) Filed: Nov. 28, 2023

(51) Int. Cl. H01M 50/691; G05D 9/04; H01M 50/204; H01M 50/249

(52) U.S. Cl. CPC H01M 50/691; G05D 9/04; H01M 50/204; H01M 50/249; H01M 2220/20

(57) ABSTRACT

A battery pack drain assembly includes a drain housing having an outer wall that is annular and an inner wall that is annular, an annular channel defined between the outer wall and the inner wall, and a primary drain valve disposed at least partially within the inner wall. The primary drain valve is configured to open when liquid in the drain housing reaches a top of the inner wall.

### INTRODUCTION

The subject disclosure relates to vehicles, and in particular to a drain assembly for a vehicle battery pack.

Battery packs used in vehicles may include a drain valve that allows for draining of liquid from the battery. A smart and efficient drain valve is desirable.

### SUMMARY

In one exemplary embodiment, a battery pack drain assembly includes a drain housing having an outer wall that is annular and an inner wall that is annular. An annular channel is defined between the outer wall and the inner wall. A primary drain valve is disposed at least partially within the inner wall. The primary drain valve is configured to open when liquid in the drain housing reaches an upper portion of the inner wall.

In addition to one or more of the features described herein, the battery pack drain assembly includes a shoulder extending from an upper portion of the inner wall, wherein the shoulder and the inner wall define a valve seat.

In addition to one or more of the features described herein, an opening is formed in the shoulder, and the primary drain valve passes through the opening.

In addition to one or more of the features described herein, the battery pack drain assembly includes a secondary drain valve disposed on the outer wall.

In addition to one or more of the features described herein, the secondary drain valve is a check valve.

In addition to one or more of the features described herein, the secondary drain valve is a one-way valve.

In addition to one or more of the features described herein, the secondary drain valve is a flapper valve.

In addition to one or more of the features described herein, the secondary drain valve is formed of a membrane that, when the secondary drain valve is closed, allows water vapor to pass through while preventing liquid from passing through.

In addition to one or more of the features described herein, the drain housing includes a lower housing that includes the inner wall and the outer wall, and an upper housing mounted on the lower housing to form an enclosed space therein.

In addition to one or more of the features described herein, the battery pack drain assembly includes a secondary drain valve disposed on the outer wall, wherein the upper housing includes a secondary drain recess above the secondary drain valve.

In addition to one or more of the features described herein, the upper housing is mounted on the lower housing via a fastener.

In addition to one or more of the features described herein, the upper housing is removably mounted on the lower housing via a fastener.

In addition to one or more of the features described herein, the inner wall is taller than the outer wall.

In addition to one or more of the features described herein, the primary drain valve includes a sensor that senses when liquid reaches the top of the inner wall.

In another exemplary embodiment, a battery pack assembly includes a battery pack housing including a battery pack housing floor. A plurality of battery cells is disposed in the battery pack housing, wherein a battery pack drain assembly is embedded in the battery pack housing floor. The battery pack drain assembly includes a drain housing including an outer wall that is annular and an inner wall that is annular. An annular channel is defined between the outer wall and the inner wall. A primary drain valve is disposed at least partially within the inner wall. The primary drain valve is configured to open when liquid in the drain housing reaches an upper portion of the inner wall.

In addition to one or more of the features described herein, the battery pack drain assembly includes a secondary drain valve disposed on the outer wall.

In addition to one or more of the features described herein, the secondary drain valve is a check valve.

In addition to one or more of the features described herein, an upper surface of the secondary drain valve is level with or lower than the battery pack housing floor.

In addition to one or more of the features described herein, the battery pack drain assembly is disposed at a lowermost portion of the battery pack housing floor.

In yet another exemplary embodiment, a vehicle includes a battery pack assembly including a battery pack housing including a battery pack housing floor. A plurality of battery cells is disposed in the battery pack housing. The vehicle includes a cooling system for cooling the battery cells. A battery pack drain assembly is embedded in the battery pack housing floor. The battery pack drain assembly includes a lower housing including an outer wall that is annular, an inner wall that is annular, and a shoulder extending inward from a top of the inner wall. An upper housing is mounted on the lower housing to form an enclosed space therein. An annular channel is defined between the outer wall and the inner wall. A primary drain valve is disposed through an opening in the shoulder and at least partially within the inner wall. A secondary drain valve that is a one-way valve is disposed on the outer wall. The primary drain valve is configured to open when liquid in the drain housing reaches the shoulder.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a is a left side view of a vehicle including a battery pack assembly having a battery pack drain assembly according to a non-limiting example;

FIG. 2 is a schematic view of battery pack assembly including a battery pack drain assembly according to a non-limiting example;

FIG. 3 is a top perspective view of a battery pack drain assembly according to a non-limiting example;

FIG. 4. is a cross-sectional view of the battery pack drain assembly shown in FIG. 3 taken at 4-4;

FIG. 5 is a top perspective view of a lower housing and a main drain valve according to a non-limiting example;

FIG. 6 is a cross-sectional view of the lower housing and the main drain valve shown in FIG. 5 taken at 6-6; and

FIG. 7 is a bottom view of an upper housing and secondary drain valves according to a non-limiting example.

### DETAILED DESCRIPTION

The following description is merely exemplary in nature and is not intended to limit the present disclosure, its application or uses. It should be understood that throughout the drawings, corresponding reference numerals indicate like or corresponding parts and features.

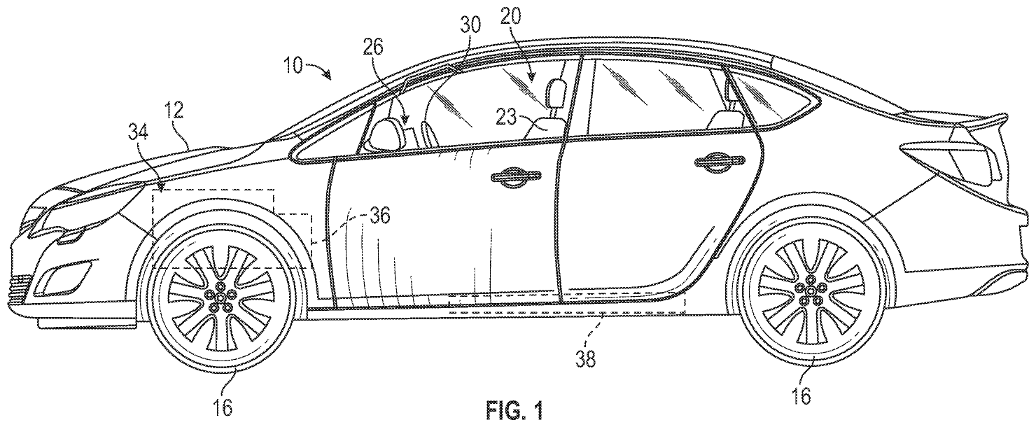

A vehicle 10 according to a non-limiting example is shown in FIG. 1. The vehicle 10 includes a body 12 supported on a plurality of wheels 16. One or more of the plurality of wheels 16 are steerable. The body 12 defines, in part, a passenger compartment 20 having seats 23 positioned behind a dashboard 26. A steering control 30 is arranged between seats 23 and a dashboard 26. The steering control 30 is operated to control orientation of the steerable wheel(s) 16.

The vehicle 10 includes an electric motor 34 connected to a transmission 36 that provides power to one or more of the plurality of wheels 16. A rechargeable energy storage system 38 is arranged in the body 12 and provides power to the electric motor 34. While specific locations are shown for the electric motor 34, the transmission 36, and the rechargeable energy storage system 38 in FIG. 1, these locations are merely exemplary and not limiting, and locations of these structures may vary.

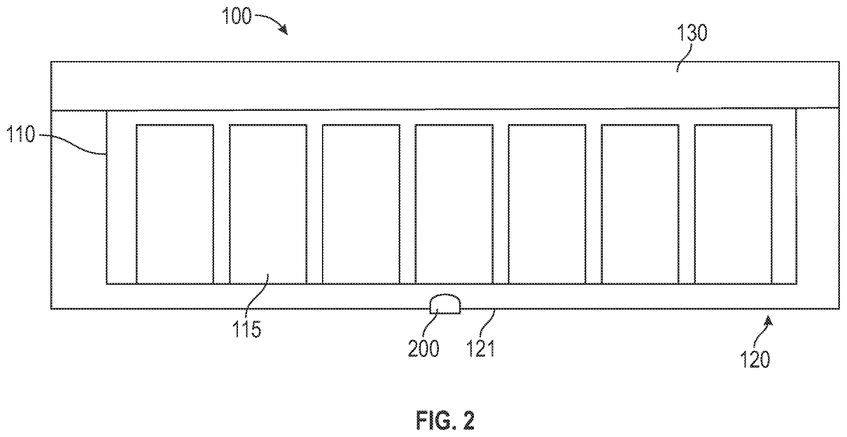

A battery pack assembly 100 according to a non-limiting example is shown in FIG. 2. According to one or more embodiments, the battery pack assembly 100 may be part of the rechargeable energy storage system 38 shown in FIG. 1. The battery pack assembly 100 may include a battery module 110 having a plurality of battery cells 115. According to one or more embodiments, the battery module 110 is disposed inside a battery pack housing 120. The battery module 110 and the battery pack housing 120 may together be considered a battery pack assembly. While FIG. 2 shows a single battery module 110 within the battery pack housing 120, multiple battery modules 110 may be disposed in the battery pack housing 120. The battery cells 115 may be pouch cells, prismatic cells, cylindrical cells, or other battery cells known in the art. According to one or more embodiments, the battery pack assembly 100 includes a cooling system 130 for removing heat from the battery module 110.

According to one or more embodiments, the battery pack housing 120 may include a battery pack housing floor 121. According to one or more embodiments, a battery pack drain assembly 200 is disposed on the battery pack housing floor 121. The battery pack drain assembly 200 is positioned at a lowermost portion of the battery pack housing floor 121 such that liquid may flow via gravity to the battery pack drain assembly 200.

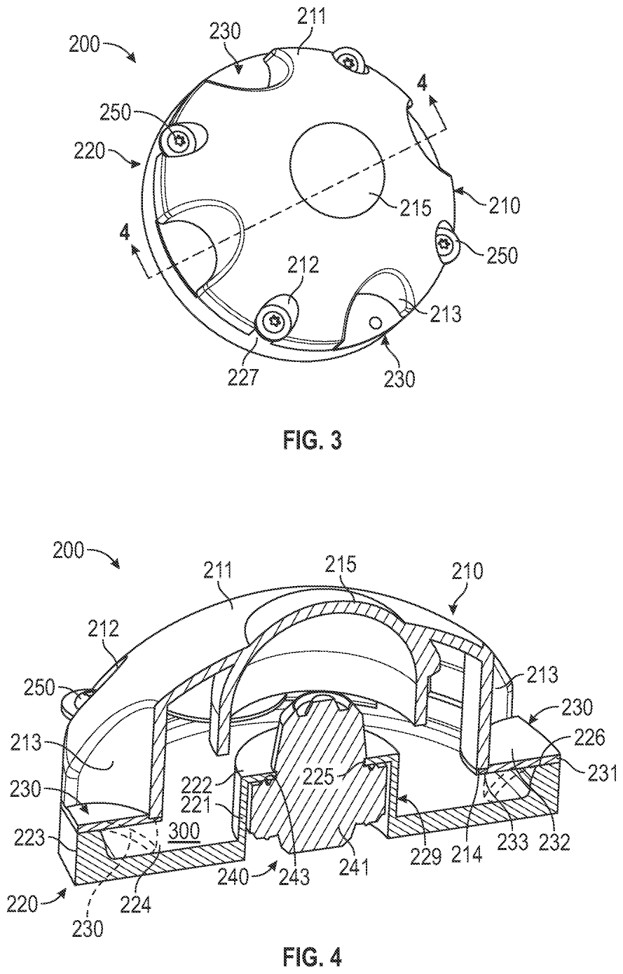

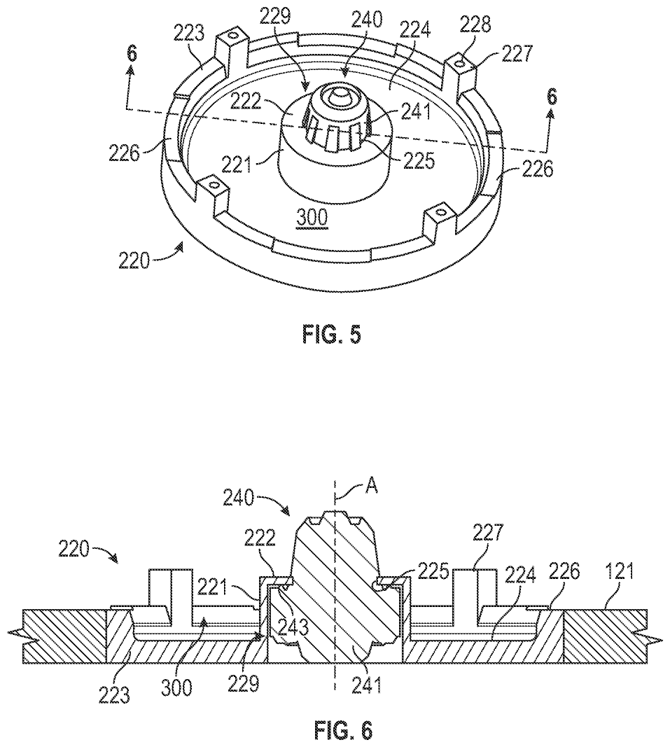

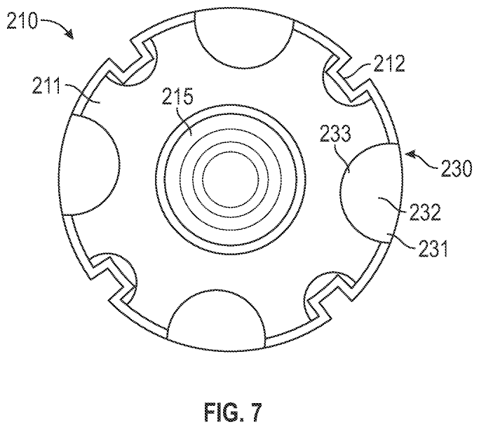

FIG. 3 shows a battery pack drain assembly 200 according to one or more embodiments, and FIG. 4 shows cross-sectional view of the battery pack drain assembly 200 taken at 4-4 in FIG. 3. FIG. 5 shows a lower housing 220 and a primary drain valve 240 according to one or more embodiments, and FIG. 6 shows a cross-sectional view of the lower housing 220 and the primary drain valve 240 taken at 6-6 in FIG. 5. FIG. 7 shows an upper housing 210 and secondary drain valves 230 according to one or more embodiments.

According to one or more embodiments, the battery pack drain assembly 200 includes an upper housing 210, a lower housing 220, a plurality of secondary drain valves 230, a primary drain valve 240, and a plurality of fasteners 250. While the battery pack drain assembly 200 is shown as having four secondary drain valves 230 and four fasteners 250, the present disclosure is not limited thereto. For example, there may be one secondary drain valve 230 and/or one fastener 250, or any plurality of secondary drain valves 230 and/or fasteners 250.

According to one or more embodiments, the upper housing 210 may include a main body 211 configured as a circular dome. According to one or more embodiments, the upper housing 210 may have another shape, such as a cylindrical shape or a rectangular box-shape. A plurality of fastener recesses 212 may be formed at a perimeter of the main body 211 that are structured to have fasteners 250 pass therethrough. According to one or more embodiments, the fastener recesses 212 may include a curved surface. According to one or more embodiments, each of the fastener recesses 212 may include an opening for a portion of the fastener 250 to pass through as well as an abutment surface for the head of the fastener 250 to create a downward force on the upper housing 210 towards the lower housing 220. A plurality of secondary drain recesses 213 may be formed at a perimeter of the main body 211. Each of the secondary drain recesses 213 may include a curved surface. According to one or more embodiments, the fastener recesses 212 may be circumferentially offset from the secondary drain recesses 213. A bottom surface 214 of each of the secondary drain recesses 213 may abut an upper surface of an inner portion 233 of the secondary drain valve 230 to form a seal when the secondary drain valve 230 is closed. An inner dome structure 215 may be formed at a center portion of the main body 211 of the upper housing 210.

According to one or more embodiments, the lower housing 220 may include an inner wall 221, an outer wall 223, and a floor 224 extending between the inner wall 221 and the outer wall 223. The inner wall 221 and the outer wall 223 may be annular structures that continuously extend around a center axis A of the lower housing 220. The inner wall 221, the floor 224, and the outer wall 223 may define an annular channel 300 in a space between the inner wall 221 and the outer wall 223. A valve seat 229 may be formed at a central portion of the lower housing 220. The valve seat 229 includes the inner wall 221 and a shoulder 222 extending from an upper portion thereof. The shoulder 222 extends radially inwardly towards the center axis A of the lower housing 220. The shoulder 222 may include a primary drain valve opening 225 at a radially center portion thereof in which the primary drain valve 240 may be received. According to one or more embodiments, the inner wall 221 may be taller than the outer wall 223. The outer wall 223 may include a plurality of secondary drain valve attachment surfaces 226 that are recessed downward from the remainder of the outer wall 223. A bottom surface of an outer portion 231 of the secondary drain valve 230 may be attached to each of the secondary drain valve attachment surfaces 226 via adhesives, bonding, or any other attachment method. Alternatively, the secondary drain valve 230 may be formed as a unitary structure with the lower housing 220. A plurality of attachment posts 227 that are circumferentially offset from each other may protrude upwardly from the outer wall 223. Each of the plurality of attachment posts 227 may have an aperture 228 formed therein. A portion of the fastener 250 may be inserted into the aperture 228. For example, if the fastener 250 is a screw, an inner surface of the aperture 228 may be threaded, and the threaded portion of the screw may be inserted into the aperture 228 to secure the screw within the aperture 228. The upper housing 210 may be mounted on the lower housing 220 to form an enclosed space therein, with the fastener 250 securing the upper housing 210 to the lower housing 220.

According to one or more embodiments, the battery pack drain assembly 200 may be at least partially embedded in the battery pack housing floor 121 of the battery pack housing 120 as shown in FIG. 2. According to one or more embodiments, the lower housing 220 is partially embedded in the battery pack housing floor 121 such that the top surface of the secondary drain valve 230 may be level with or lower than the surrounding battery pack housing floor 121. Thus, liquid on the battery pack housing floor 121 may flow via gravity to the battery pack drain assembly 200. The upper housing 210 may be mounted on the lower housing 220, together forming a drain housing.

The secondary drain valves 230 may be check valves that open when liquid (e.g., water) is outside of the battery pack drain assembly 200 allowing the fluid to flow into the annular channel 300. According to one or more embodiments, the secondary drain valves 230 may be one-way valves. The secondary drain valves 230 may be, for example, flapper valves, as shown in FIGS. 3, 4, and 7. According to one or more embodiments, the secondary drain valves 230 may be silicone flapper valves. According to one or more embodiments, each of the secondary drain valves 230 may be formed of a membrane that, when closed, still allows water vapor to pass therethrough while preventing liquid from passing therethrough. Each of the secondary drain valves 230 may include a main body 232 extending between an outer portion 231 that may be attached to the secondary drain valve attachment surface 226 and an inner portion 233 that may abut a bottom surface 214 of the secondary drain recess 213 which functions as a valve seat. As shown in FIG. 4, the main body 232 of the secondary drain valve 230 may deform downward when the liquid reaches a top of the main body 232 to open the secondary drain valve 230. While the secondary drain valves 230 are shown as flapper valves, the secondary drain valves 230 may instead be an umbrella valve, a mushroom valve, a butterfly check valve, a ball check valve, a diaphragm check valve, a lift check valve, a swing check valve, an in-line check valve, a duckbill valve, or other check valves.

Primary drain valve 240 is disposed within the primary drain valve opening 225. The primary drain valve 240 may include a main body 241 and a seal surface 243 that abuts a lower surface of the shoulder 222 to form a seal when the primary drain valve 240 is closed. A presence of liquid above the shoulder 222 opens the primary drain valve 240 to allow the liquid to drain out of the battery pack drain assembly 200. The primary drain valve 240 may include a sensor that senses the presence of liquid above the shoulder 222 to open the primary drain valve 240, and close the primary drain valve 240 when the sensor no longer senses the presence of liquid. The primary drain valve 240 may be an absorption-style drain valve, or any other valve known in the art capable of draining liquid from the battery pack drain assembly 200.

According to one or more embodiments, the plurality of fasteners 250 fasten the upper housing 210 to the lower housing 220. The fasteners 250 may be screws that pass through the fastener recesses 212 of the upper housing 210 into the apertures 228 in the attachment posts 227 of the lower housing 220. The fasteners 250 may be removable so that the upper housing 210 can be removed from the lower housing 220 to clean the annular channel 300 of liquid, dust, or debris. While the fasteners 250 are shown as screws as a non-limiting example, according to one or more embodiments, the fasteners may be a bolt, rivet, anchor, adhesives, or any other fastener known in the art. According to one or more embodiments, the upper housing 210 may be bonded to the lower housing 220. According to one or more embodiments, the upper housing 210 and the lower housing 220 may be attached by press-fitting.

A liquid (e.g., water) may enter battery pack housing 120 of battery pack assembly 100 during use. For example, condensation may drip to the battery pack housing floor 121 (e.g., from a cooling system 130). In such a case, the liquid may flow slowly and/or intermittently to the battery pack housing floor 121. Such an event will be referred to as an intermittent liquid event. As another example, a liquid leak may occur within the battery pack assembly 100 or some external system that results in liquid ingress into the battery pack housing 120. Such an event will be referred to as a high flowrate liquid event. As battery pack housing 120 may include battery cells 115 that are high voltage, the accumulation of liquid within the battery pack housing 120 is undesirable. Thus, the drain valve is disposed on the battery pack housing floor 121 to drain the liquid. However, while disposing a drain valve that opens every time an intermittent liquid event occurs or if a high flowrate liquid event occurs may drain the liquid out of the battery pack housing 120, there is a risk of liquid entering the drain valve from below into the battery pack housing 120 every time the drain valve is opened.

Therefore, as described herein, one or more embodiments of the battery pack drain assembly 200 may reduce the frequency of opening of the primary drain valve 240 while maintaining the ability to drain the liquid from the battery pack housing 120 as desired. Furthermore, one or more embodiments may prevent any liquid ingress from below the primary drain valve 240 from reaching the battery pack housing 120 or any of the battery cells 115 or electrical components therein.

As described, the upper surface of the secondary drain valve 230 may be level with or lower than the battery pack housing floor 121 surrounding the battery pack drain assembly 200. As such, liquid on the battery pack housing floor 121 may open the secondary drain valve 230 and flow into the annular channel 300 of the lower housing 220. The secondary drain valve 230 may close once most or all of the liquid on the battery pack housing floor 121 has emptied into the battery pack drain assembly 200. For intermittent liquid events, the annular channel 300 holds the liquid, which the closed secondary drain valve 230 may keep from splashing back into the battery pack housing 120. The primary drain valve 240 may not open until liquid fills the annular channel 300 to a level at or above the shoulder 222 of the valve seat 229. Once the liquid has reached the level at or above the shoulder 222 of the valve seat 229, the liquid will open the primary drain valve 240 and drain out of the battery pack drain assembly 200. In a high flowrate liquid event, liquid may flow onto the battery pack housing floor 121 at a relatively high flowrate. Due to the relatively high flowrate, the liquid will open the secondary drain valve(s) 230 and fill up the annular channel 300 to the shoulder 222 and open the primary drain valve 240 to flow out of the battery pack drain assembly 200. As such, for intermittent liquid events, the frequency of opening of the primary drain valve 240 may be reduced, as the liquid may be stored in the annular channel 300 instead of opening the primary drain valve 240. For a high flowrate liquid event, the annular channel 300 may fill relatively quickly to reach the level of the shoulder 222 of the valve seat 229 to open the primary the primary drain valve 240 such that the battery pack drain assembly 200 may be able to effectively drain liquid from the battery pack housing 120 during a high flowrate liquid event.

According to one or more embodiments, the battery pack drain assembly 200 may effectively drain the battery pack housing 120 during a high flowrate liquid event and/or select intermittent liquid events as desired. According to one or more embodiments, by reducing the frequency of opening of the primary drain valve 240 during intermittent liquid events, the risk of liquid ingress or foreign contaminant into the battery pack drain assembly 200 through an open primary drain valve 240 may be reduced. According to one or more embodiments, even if there is liquid ingress into the battery pack drain assembly 200 through an open primary drain valve 240, the secondary drain valve 230, which may be a check valve or a one-way valve, will block the liquid from reaching the battery pack housing 120.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery pack drain assembly, comprising:
a drain housing comprising an outer wall that is annular and an inner wall that is annular;
an annular channel defined between the outer wall and the inner wall; and
a primary drain valve disposed at least partially within the inner wall,
wherein the primary drain valve is configured to open when liquid in the drain housing reaches an upper portion of the inner wall.

2. The battery pack drain assembly of claim 1, further comprising: a shoulder extending from a top of the inner wall, wherein the shoulder and the inner wall define a valve seat.

3. The battery pack drain assembly of claim 2, wherein an opening is formed in the shoulder, and wherein the primary drain valve passes through the opening.

4. The battery pack drain assembly of claim 1, further comprising a secondary drain valve disposed on the outer wall.

5. The battery pack drain assembly of claim 4, wherein the secondary drain valve is a check valve.

6. The battery pack drain assembly of claim 4, wherein the secondary drain valve is a one-way valve.

7. The battery pack drain assembly of claim 4, wherein the secondary drain valve is a flapper valve.

8. The battery pack drain assembly of claim 4, wherein the secondary drain valve is formed of a membrane that, when the secondary drain valve is closed, allows water vapor to pass through while preventing liquid from passing through.

9. The battery pack drain assembly of claim 1, wherein the drain housing comprises a lower housing that includes the inner wall and the outer wall, and an upper housing mounted on the lower housing to form an enclosed space therein.

10. The battery pack drain assembly of claim 9, further comprising: a secondary drain valve disposed on the outer wall, wherein the upper housing comprises a secondary drain recess above the secondary drain valve.

11. The battery pack drain assembly of claim 9, wherein the upper housing is mounted on the lower housing via a fastener.

12. The battery pack drain assembly of claim 9, wherein the upper housing is removably mounted on the lower housing via a fastener.

13. The battery pack drain assembly of claim 1, wherein the inner wall is taller than the outer wall.

14. The battery pack drain assembly of claim 1, wherein the primary drain valve comprises a sensor that senses when liquid reaches the top of the inner wall.

15. A battery pack assembly, comprising:
a battery pack housing comprising a battery pack housing floor;
a plurality of battery cells disposed in the battery pack housing; and
a battery pack drain assembly embedded in the battery pack housing floor,
wherein the battery pack drain assembly comprises:
a drain housing comprising an outer wall that is annular and an inner wall that is annular,
an annular channel defined between the outer wall and the inner wall, and
a primary drain valve disposed at least partially within the inner wall, and
wherein the primary drain valve is configured to open when liquid in the drain housing reaches a top of the inner wall.

16. The battery pack assembly of claim 15, wherein the battery pack drain assembly further comprises a secondary drain valve disposed on the outer wall.

17. The battery pack assembly of claim 16, wherein the secondary drain valve is a check valve.

18. The battery pack assembly of claim 16, wherein an upper surface of the secondary drain valve is level with or lower than the battery pack housing floor.

19. The battery pack assembly of claim 15, wherein the battery pack drain assembly is disposed at a lowermost portion of the battery pack housing floor.

20. A vehicle comprising:
a battery pack assembly, comprising:
a battery pack housing comprising a battery pack housing floor;
a plurality of battery cells disposed in the battery pack housing;
a cooling system for cooling the battery cells; and
a battery pack drain assembly embedded in the battery pack housing floor,
wherein the battery pack drain assembly comprises:
a lower housing comprising an outer wall that is annular, an inner wall that is annular, and a shoulder extending inward from an upper portion of the inner wall,
an upper housing mounted on the lower housing to form an enclosed space therein,
an annular channel defined between the outer wall and the inner wall,
a primary drain valve disposed through an opening in the shoulder and at least partially within the inner wall, and
a secondary drain valve that is a one-way valve disposed on the outer wall, and
wherein the primary drain valve is configured to open when liquid in the drain housing reaches the shoulder.
